(19) United States
(12) Patent Application Publication
(10) Pub. No.: US 2006/0265691 A1
(43) Pub. Date: Nov. 23, 2006

(54) System and method for generating test cases

(75) Inventors: Tamir Klinger, New York, NY (US); Amitkumar M. Paradkar, Mohegan Lake, NY (US); Clay E. Williams, New York, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Business Machines Corporation, Armonk, NY (US)

(21) Appl. No.: 11/133,255

(22) Filed: May 20, 2005

(51) Int. Cl. G06F 9/44

(52) U.S. Cl. 717/124

(57) ABSTRACT

A method and system for automatically generating a test case for object-oriented software includes providing a model of the object-oriented software, determining a test state for the object-oriented software, and determining a sequence of test steps for the object-oriented software based upon the test state.

### BACKGROUND OF THE INVENTION

1. Field of the Invention

The present invention generally relates to a software design and development system for software testing. In particular, the present invention relates to methods and systems for generating test cases.

2. Description of the Related Art

When testing software systems, developing an effective and efficient set of test cases is a complex problem. A suite of test cases is effective if it thoroughly covers combinations of inputs, actions, and sequences of actions, enhancing the likeliness it will encounter defects in the software. A suite is efficient if it provides such coverage without unnecessary redundancy, which would unduly increase the testing effort.

Typically, when a tester tests a software system, the tester or test program takes an action against the system being tested and receives a result or response back from the tested system. The received result is compared against an expected result to determine if the system is working correctly. The tester then takes another action, gets some other response, and then the tester performs a series of action/response sequences. Sometimes, the order of this sequence depends upon the responses, which were received earlier in the sequence. The number of ways that the sequences may be combined is very large.

Also, for most actions where the tester stimulates the system in a step in the sequence, the number of potential inputs to that particular action is very large. So, there are at least two places where one runs into a large number of combinations, which leads to a combinatorial explosion problem.

Test generation is an area in which significant research has been performed. Most of the prior research has focused on finite-state based testing, which uses a finite state representation of the system being tested to generate sequences of actions, which may be used to test the system. The actions are determined by seeking to cover states, transitions between states, or some combination thereof. These methods suffer from problems dealing with combinatorial explosion. Also, these techniques are very hard to optimize from an internal state-based viewpoint.

Some conventional methods of testing rely upon a Unified Modeling Language (UML) based representation for automating test generation for distributed systems (see http://www.agedis.de/), protocol conformance testing (L. Du Bousquet, H. Martin, and J.-M. Jezequel, Conformance testing from UML specifications experience report. In Proceedings of the Workshop on Practical UML-based Rigorous Development Methods, Toronto, CA, 2001, 43-55), component testing (S. Pickin, C. Jard, T. Heuillard, J.-M. Jezequel, and P. Desfray. A UML-integrated test description language for component testing. In Proceedings of the Workshop on Practical UML-based Rigorous Development Methods, Toronto, CA, 2001, 208-223), and the development of a standard representation in UML for describing conformance test cases (UML testing profile: Request for proposal, 2001, OMG document: AD/01-07-08).

An additional difficulty in finite-state based test generation is model representation. Because the coverage focus of the test generation method is on a system state, models often require a very high degree of detail and can be difficult to construct.

The automation of test case creation from black-box models of a system to be tested has long been a goal of computer scientists. There are three conventional techniques that have been employed to automate test case creation. These conventional techniques include model-based techniques, algebraic techniques, and finite state based techniques. These conventional techniques are often used in combination with each other in an attempt to provide a more robust and/or useful technique.

Conventionally, a model-based or an algebraic representation is converted into a finite state-based representation. Algorithms for traversing that representation are then used to generate test cases. These conventional techniques have at least two problems.

First, the representations that are conventionally used to capture the system in enough detail to be able to test it are typically arduous to capture and create. A conventional representation is an operational description of the behavior of the system to be tested along with a system state representation. Conventional techniques use very low levels of constructs such as arrays to represent the multiplicity of a given domain entity. This requires the user to supply unnecessary and complex information for managing the lifecycle of a particular entity such as its creation, deletion, and updates. Also, the navigation through the arrays is done using low-level loop iterators, which adds to the complexity of the modeling effort.

Furthermore, relationships between two entities, which are related to each other in some logical sense, need to be handled through explicit references to each other in a record structure. This low level of construct also puts the onus of relationship management (such as creating and deleting a relationship between instances of two particular entities on the user, thus adding to the complexity of the model building task.

Second, these techniques almost universally suffer from state explosion problems. The size of a finite-state based model for a real world problem is usually exponentially related to the number of variables in the system being tested.

Some techniques for avoiding finite-state space explosion exist however, these techniques require detailed knowledge and precise specification that is beyond the capability of the typical tester. An example of a conventional technique for avoiding finite-state explosion is disclosed in Projected State Machine Coverage for Software Testing, by Friedman, Hartman, Nagin, and Shiran at International Software Testing and Analysis, 2002, pages 134-143. The Friedman et al. reference describes a conventional technique where a user can specify a set of interesting system states to visit or a set of interesting transitions to be covered by the user. Also, the user may also specify that certain system states and transitions should not be visited. Using this information, the test generator takes a projection of the exhaustive state space over that specified by the user thus reducing the size of the total state space to be searched. However, this requires additional knowledge about what interesting states and transitions are to be included and excluded, and creates another level of complexity for the user.

Another problem for conventional techniques is a lack of system state verification. Each operation that updates the state of the system could do so in error. A test generation tool should be able to detect possible errors in such system updates.

### SUMMARY OF THE INVENTION

In view of the foregoing and other exemplary problems, drawbacks, and disadvantages of the conventional methods and structures, an exemplary feature of the present invention is to provide a method and structure in which test cases for object-oriented software are automatically generated.

In a first exemplary aspect of the present invention, a method for automatically generating test cases for object-oriented software includes providing a model of the object-oriented software, determining test states for the object-oriented software, and determining a sequence of test steps for the object-oriented software based upon the test states.

In a second exemplary aspect of the present invention, a method for deploying computer infrastructure for automatically generating test cases for object-oriented software, includes integrating computer-readable code into a computing system. The computer-readable code includes instructions for providing a model of the object-oriented software, instructions for determining test states for the object-oriented software, and instructions for determining a sequence of test steps for the object-oriented software based upon the test states.

In a third exemplary aspect of the present invention, a signal bearing medium executable by a digital data processing unit for automatically generating test cases for object-oriented software includes providing a model of the object-oriented software, determining test states for the object-oriented software, and determining a sequence of test steps for the object-oriented software based upon the test states.

In a fourth exemplary aspect of the present invention, a system for automatically generating test cases for object-oriented software includes means for providing a model of the object-oriented software, means for determining test states for the object-oriented software, and means for determining a sequence of test steps for the object-oriented software based upon the test states.

An exemplary embodiment of the present invention applies a fault-modeling technique to a representation of a system to determine a set of goal states that may be used to test the system.

Another exemplary embodiment of the present invention uses a planning algorithm to create test cases that attempt to reach goal states. The use of a planning algorithm is advantageous because a planning algorithm supports testing of dynamic state spaces—spaces in which objects can be created and deleted—as well as, planning with numeric, string, boolean and set constraints.

Most conventional planners assume that the set of objects being manipulated by the planner are fixed and known at the start of the planning process. However, a planner in accordance with an exemplary embodiment of the present invention allows objects to be created and destroyed dynamically, as the planning process proceeds. This more closely mirrors the behavior of object-oriented software systems.

Also, a planner in accordance with an exemplary embodiment of the present invention allows unbounded numeric parameters on the actions considered by the planner. As an example, an operation on an automated teller machine (ATM) to withdraw money might take two parameters: the account number and the amount of money to withdraw. Most conventional planners cannot handle the “amount” argument because it is an unbounded real number. A few conventional planners can handle unbounded real numbers, but they do not support dynamic object creation or any of the other additional features, which are incorporated into an exemplary embodiment of the present invention.

A planner in accordance with an exemplary embodiment of the present invention can also represent sets of objects (like the set of all projects belonging to a department) and can manipulate those sets to add or remove elements.

Additionally, a planner in accordance with an exemplary embodiment of the present invention may support operations on sets that may be used to constrain the planning process. For example, a modeler in accordance with an exemplary embodiment of the present invention may constrain the number of projects belonging to a department to be greater or equal some value or may constrain the sum of the budgets of the set of projects in a department to be some value. No conventional planners support this feature.

An exemplary embodiment of the present invention generates a set of test objectives using a fault model for a test generation tool to target. These test objectives are expressed as guard conditions in predicate logic, and are refined and transformed into goal conditions. The goal conditions are used in conjunction with planning technology to generate a part of the test sequences that avoid a random search of a system state space.

These and many other advantages may be achieved with the present invention.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary hardware/information handling system 100 for using and incorporating the present invention therein;

FIG. 2 illustrates a signal bearing medium 200 (e.g., storage medium) for storing steps of a program of a method according to the present invention;

FIG. 3 illustrates an exemplary test generation tool 300 in accordance with the present invention;

FIG. 4 illustrates a flowchart 400 for an exemplary normalization routine in accordance with the present invention;

FIG. 5 illustrates a flowchart 500 of a control routine for a goal generator 312 of FIG. 3;

FIG. 6 illustrates a flowchart 600 of the operation of the concretizer 316 of FIG. 3;

FIG. 7 illustrates a data domain model 700 upon which operation of an exemplary embodiment of the present invention is demonstrated;

FIG. 8 illustrates a use case model 800 in accordance with the data domain model 700 of FIG. 7;

FIG. 9 illustrates an exemplary concrete test case 900 that was created in accordance with an exemplary embodiment of the present invention;

FIG. 10 illustrates an exemplary executable test case 1000 that was created in accordance with an exemplary embodiment of the present invention;

FIG. 11 illustrates an execution template 1100 that was created in accordance with an exemplary embodiment of the present invention;

FIG. 12 illustrates an exemplary planning graph 1200 that was created in accordance with an exemplary embodiment of the present invention; and

FIG. 13 illustrates a linearized plan 1300 that was extracted from the planning graph 1200 of FIG. 12 in accordance with an exemplary embodiment of the present invention.

### DETAILED DESCRIPTION OF EXEMPLARY EMBODIMENTS OF THE INVENTION

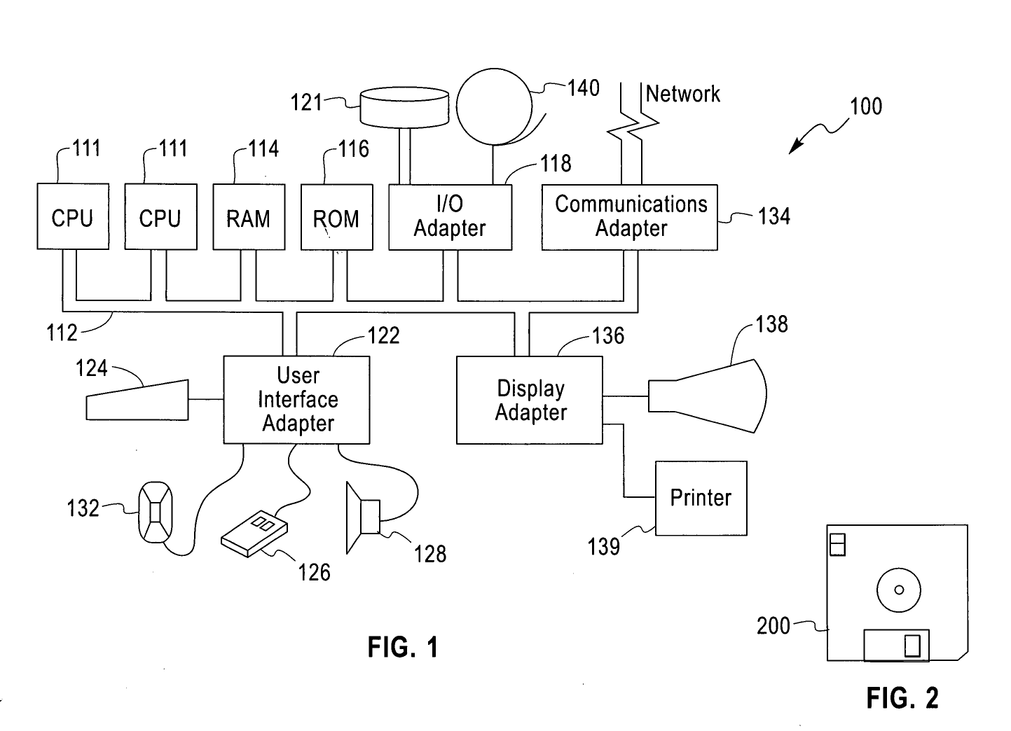

Referring now to the drawings, and more particularly to FIGS. 1-13, there are shown exemplary embodiments of methods and structures in accordance with the present invention.

An exemplary embodiment of the present invention uses the concept of a use case that defines a piece of functionality, which is of interest to a user. In other words, the use case presents the tested system in a manner that is similar to a user view of that system. For example, in a word processor a user might want to save a file. The user thinks, “I am going to save a file.” Thus, “save file” becomes a use case. A use case may include several steps. In this example, the user might click “save as”, type the filename and then click “OK.” The system might respond with “That file name already exists, do you want to overwrite it?” and the user responds “Yes.” Thus, there are many operations that might happen for a particular use case. Those steps are actions within the use case.

There is another concept called an “Actor.” In a real system, there may be many actors. Examples of actors may include a system administrator, a regular user and a customer. Different actors often have permission to only use certain subsets of use cases. Those subsets may overlap. Therefore, one may want to account for the functionality for each actor. In this manner, one may ensure complete testing from the perspective of each actor.

An exemplary embodiment of the invention also uses the concept of “test case,” which is a higher level construct than the use case. A test case is a sequence of use case invocations. A test case may include three parts. The first part is called a “Set Up” sequence, which brings the system under test (SUT) from a user provided initial state to a desired system state. The second part is a test use case invocation, which invokes one particular use case, and the third part is called a verification sequence, which verifies updates to the system state after the test use case invocation.

In accordance with an exemplary embodiment of the present invention there are three types of test cases, each of which is a concatenation of the three subsequences described above. An “abstract” test case is a sequence of use case invocations each of which has a set of constraints on its parameters. A “concrete” test case is an instantiation of an abstract use case where the constraints on parameters are replaced by a concrete parameter value that satisfies those constraints. A “reified” test case is a concrete test case, which may be executed in the target execution environment. A reified test case may be obtained from a concrete test case by substitution from a user defined mapping. A test case is a sequence of use cases. Each use case may have an outcome that affects the state of the system and may also provide some feedback to a user. As an example, in the “save file” use case, the feedback to the user may be “file saved.” Thus, the state of the system is reflected in the fact that the file was saved.

Another exemplary embodiment of the present invention, normalizes a model of the system being tested into a representation that makes it suitable for planning-based algorithms.

FIG. 1 illustrates a typical hardware configuration of a system 100 in accordance with the invention and which preferably has at least one processor or central processing unit (CPU) 111.

The CPUs 111 are interconnected via a system bus 112 to a random access memory (RAM) 114, read-only memory (ROM) 116, input/output (I/O) adapter 118 (for connecting peripheral devices such as disk units 121 and tape drives 140 to the bus 112), user interface adapter 122 (for connecting a keyboard 124, mouse 126, speaker 128, microphone 132, and/or other user interface device to the bus 112), a communication adapter 134 for connecting an information handling system to a data processing network, the Internet, an Intranet, a personal area network (PAN), etc., and a display adapter 136 for connecting the bus 112 to a display device 138 and/or printer 139 (e.g., a digital printer or the like).

In addition to the hardware/software environment described above, a different aspect of the invention includes a computer-implemented method for performing the methods described below. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising a signal-bearing medium tangibly embodying a program of machine-readable instructions executable by a digital data processor incorporating the CPU 111 and hardware above, to perform the method of the invention.

This signal-bearing medium may include, for example, a RAM contained within the CPU 111, as represented by the fast-access storage for example. Alternatively, the instructions may be contained in other signal-bearing media, such as a magnetic data storage diskette 200 (FIG. 2), directly or indirectly accessible by the CPU 111.

Whether contained in the diskette 200, the computer/CPU 111, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may include software object code.

Many different types of data processing systems are contemplated for use by embodiments of the present invention. For example, an exemplary embodiment of the present invention may be implemented using a plurality of separate electronic circuits or devices (e.g., hardwired electronic or logic circuits, or programmable logic devices such as PLDs, PLAs, PALs, or the like). A suitable programmed general, purpose computer, e.g., a microprocessor, micro-controller or other processor device (CPU or MPU), either alone or in conjunction with one or more peripherals (e.g. integrated circuit) data and signal processing devices can be used to implement the invention.

In general, any device or assembly of devices on which a finite state machine capable of implementing the flow charts shown in the figures may be used as a controller for an exemplary embodiment of the present invention.

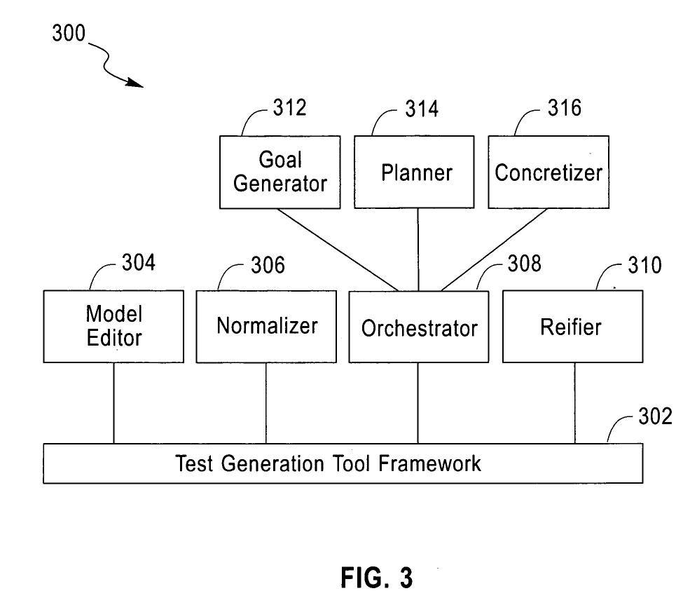

In an exemplary embodiment of the present invention, the system 100 may also contain an integrated modeling/programming environment (not shown), which may invoke test generation tools. The system 100 may also include data memory that includes data and objects that are related to the execution of the program development tools and the integrated modeling/programming environment in accordance with the present invention Referring to FIG. 3, an exemplary test generation tool 300 in accordance with an exemplary embodiment of the claimed invention includes a test generation tool framework 302, a model editor 304, a normalizer 306, an orchestrator 308 and a reifier 310. FIG. 3 also illustrates that the orchestrator 308 is in communication with a goal generator 312, a planner 314 and a concretizer 316.

The model editor 304 describes the structural and behavioral aspects of the software under test using an inventive model. The inventive model entities may include a domain model, a set of business rules on the domain model, and a set of use cases that describe the behavior of the software under test. A domain model is a collection of classes with attributes and associations which can be, but doesn't have to be, specified using the Unified Modeling Language (UML). Business rules are constraints or invariants expressed on the classes of the domain model. For example, if there is a class representing a bank account called “Account” which has an attribute called “balance”, a business rule on that account might state “balance >=0”. The intended meaning of this rule is that all bank accounts must always have a balance which is >=0.

The model editor 304 normalizes the model. Normalizing a model in accordance with an exemplary embodiment of the invention involves receiving a use case from the model in a form of a sequence of steps (with potential alternatives) and transforming the use case into a form where it may be executed in a single operation, such a use case is known as a “flat” use case.

In accordance with the present description a non-normalized use case is known as a “regular” use case and a normalized use case is known as a “flat” use case.

In an exemplary embodiment of the present invention the normalization may be reversible, provided that a mapping is saved during the process.

In accordance with an exemplary embodiment of the present invention, a regular use case is a sequence of steps with potential exceptional alternatives. Below is an example of a regular use case for withdrawing money from an automated teller machine (ATM).
Use Case Name: Withdraw Cash
Precondition: user.valid =true
   1. User selects the account to withdraw from.
   2. User enters the amount to withdraw.
   3. System returns cash.
   4. System debits the account balance by amount (account.balance=account.balance−amount)
Exceptions
   e3.1 [amount>account.balance]
      e3. 1.1 System displays error message
      e3.2.2 End use case

In this example, there is a precondition which states a user must be validly logged onto the ATM system. In this “withdraw cash” use case a user provides two pieces of input: the account to withdraw from and the amount. If the amount is valid, the system provides an output (the cash) and updates the balance. If the amount exceeds the balance, the system displays a message and the use case ends.

This withdraw cash use case corresponds to two possible alternatives for a system state: a valid amount state, and a state where the amount is invalid.

The flattened form of this use case is:
Use Case Name: Withdraw Cash
Precondition: user.valid=true
Inputs: account, amount

Results:

```
1. (Successful Result) [amount <= account.balance]
  Output: cash
  Update: account.balance = account.balance − amount
2. (Failing Result) [amount > account.balance]
  Output: error message
  Update: none
```

As explained above, flattening the use case in accordance with an exemplary embodiment of the present invention enables the use case to be executed in a single operation.

This operation has a set of inputs, a set of outputs, and computations, which describe updates to the system state. Normalization of a use case of a system in accordance with an exemplary embodiment of the present invention may be performed as follows. The number of results is equal to the number of exceptions defined in the use case plus one (which represents the exception-free, or successful, execution of the use case). In the example flattened use case, there are two results. The inputs are a collection of all parameters defined in the input statements in the statements of the use case. The outputs similarly come from the output statements. Finally, the updates (computations) are always associated with a result. The result with which a given computation step is associated is determined by where the computation occurs in the use case. For example, computations that occur in an exception are associated with the result defined for that exception.

An exemplary normalizing algorithm in accordance with an exemplary embodiment of the present invention as follows.
1. Create a set of possible results=number of exceptions+1
2. Place a guard on each result (the “main result” guard should be the negation of the disjunction of all of the exceptional guards)
3. For each statement in the main statement sequence
   a. If it is an input, add the parameter to the input list
   b. It if is an output, add the parameter to the output list
   c. If it is a computation, add it to the main result
4. For each exception, explore the statement sequence associated with it and handle in an identical manner to step 3.

The behavior of the software under test is described in terms of the inputs provided by an actor to the software under test, and outputs provided by the software under test to the actor, and a set of guard conditions. A guard condition that describes the relationship between user input and system state in terms of instances of the domain model and corresponding output computations described as system state updates.

A guard condition is an expression, which must be true for a particular behavior to occur. For example, “balance >=amt” might be a guard condition for a withdraw use case on an ATM system

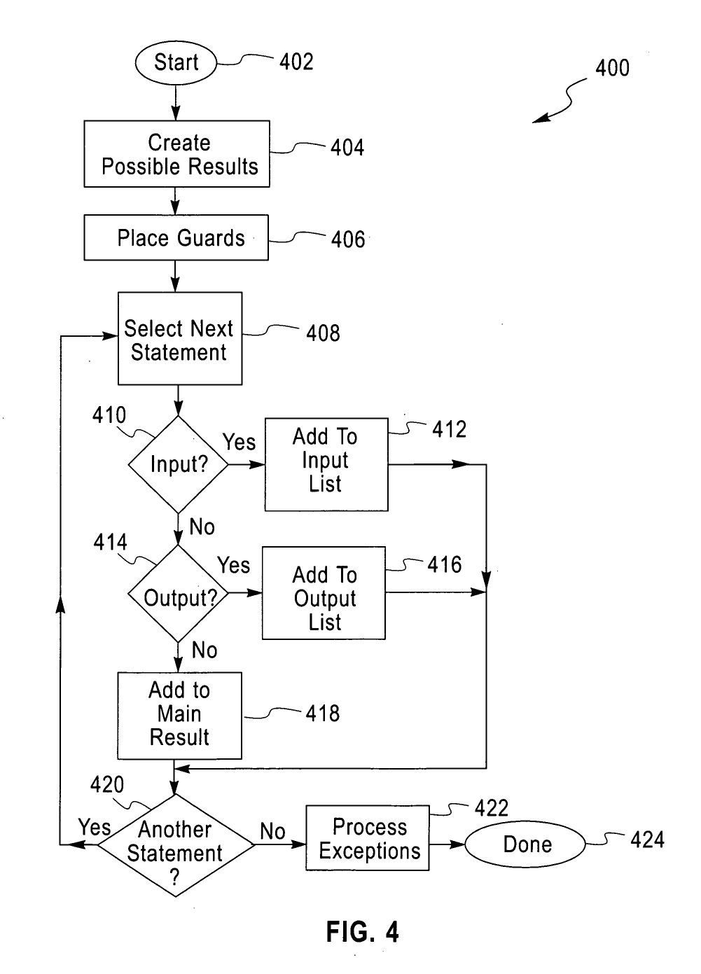

FIG. 4 illustrates a flowchart 400 for an exemplary normalization routine in accordance with the present invention. The normalizer 306 starts at step 402 and continues to step 404 where the normalizer 306 creates a set of possible results.

Next, the normalizer 306 places a guard on each result in step 408 and continues to step 408. In step 408, the normalizer 306 selects the next statement and continues to step 410. In step 410, the normalizer 306 determines whether the current statement is an input statement. If, in step 410, the normalizer 306 determines that the current statement is an input statement then the normalizer 306 continues to step 412.

In step 412, the normalizer 306 adds the parameter to the input list and continues to step 420.

If, however, in step 410, the normalizer 306 determines that the current statement is not an input statement then the normalizer 306 continues to step 414.

In step 414, the normalizer 306 determines whether the current statement is an output statement. If, in step 414, the normalizer 306 determines that the current statement is an output statement then the normalizer 306 continues to step 416.

In step 416, the normalizer 306 adds the parameter to the output list and continues to step 420.

If, however, in step 414, the normalizer 306 determines that the current statement is not an output statement then the normalizer 306 continues to step 418 where the normalizer 306 adds the parameter to the main result and then continues to step 420.

In step 420, the normalizer 306 determines whether there is another statement. If, in step 420, the normalizer 306 determines that there is another statement, then the normalizer 306 returns to step 408. If, however, the normalizer 306 determines that there is not another statement, then the normalizer 306 continues to step 422.

In step 422, the normalizer 306 explores the statement sequence for each exception and then continues to step 424 where the normalizer 306 stops.

The goal generator 312 uses invariants, pre-conditions, and state updates in the model to generate a set of goal states. The goal generator 312 may apply a fault model to the normalized model. A fault model is a well understood concept for testing hardware systems and an example of a fault model that may be used with an exemplary embodiment of the present invention is described in Switching and Finite Automata Theory by Zvi Kohavi, Second Edition McGraw-Hill, 1990.

A fault model defines the possible faults that may exist in the entity being tested (either hardware or software). Thus, a fault model provides a set of targets for a tester (either human or a tool) to aim for. In the exemplary embodiment of our current invention, the fault model identifies interesting testing objectives and produces goals for the planner 314 to try to achieve. For example, given a business rule, a fault model may identify a state in which the business rule can be broken by the application of some use case, which can affect the values constrained by the business rule. These goal states may then be used by the 314 to generate test cases. In this manner, an exemplary embodiment of the present invention allows a tester to determine whether the system being tested obeys all of the business rules for all use cases.

In other words, the goal generator 312 applies the fault model to generate conditions on the system state (called “goal conditions” or “goals”) that target errors that are likely to occur in an implementation of the system corresponding to the model.

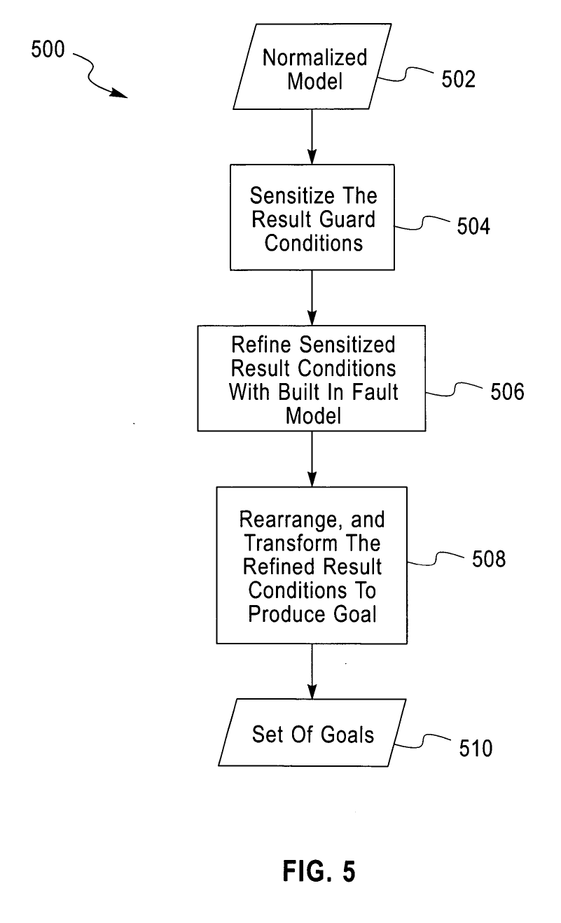

FIG. 5 illustrates a flowchart the operation of the goal generator 312 in accordance with an exemplary embodiment of the invention. The goal generator 312 starts at step 502 where the goal generator 312 receives the normalized model from the normalizer 306 (via the orchestrator 308) and continues to step 504.

In step 504, the goal generator 312 sensitizes the result guard conditions and continues to step 506. In step 506, the goal generator 312 refines the sensitized result conditions using a fault model and continues to step 508.

In step 508, the goal generator 312 rearranges, and transforms the refined result conditions to produce a set of goals and continues to step 510 where the goal generator 312 outputs the set of goals.

A purpose of the fault model is to derive “test objectives” which are interesting aspects of the system that need to be tested. A common test objective, for example, is to make sure that each result of a use case is tested at least once (possibly more depending under which the result occurs). However, one needs to ensure that each result is tested in isolation from the other possible results for a use case. For example, in the withdraw cash use case example given above, there may be two possible results, with the following result conditions: (amt<=account.balance) && (amt>200∥amt<20) for a successful withdrawal, with a failure in withdrawal otherwise. A test objective would be to ensure that each of these conditions is tested.

Additionally, when testing for a failed withdrawal, two conditions may be tested. One condition where the “amt” value exceeds an account.balance and the other condition where the “amt” value is outside a range. This is referred to in the present description as a fault sensitization step of the goal generator 312. The fault sensitization of step 504 ensures that any faults in the implementation, which correspond to the implementation of the individual conditions, do not get masked. At the end of the fault sensitization step 504 the guard conditions only include a conjunction Boolean operator.

The goal generator 312 of an exemplary embodiment of the present invention may perform boundary value testing, where the values at the extreme of a domain of values are tested in the refinement step 506. For example, for the withdraw cash use case example, a result guard condition, which says (amt<=account.balance) may be tested for two separate conditions(amt<account.balance) and (amt=account.balance).

The goal generator 312 of an exemplary embodiment of the present invention also derives result guard conditions in step 506 after the fault sensitization step 504 to produce a detailed guard condition. For example, the condition (amt<=account.balance) is split into 2 conditions (amt<account.balance); and (amt=account.balance). This is the refinement step 506 in the goal generator process flow diagram in FIG. 5.

The guard conditions obtained after the refinement step 506 are split into three constituent categorical parts in step 508. The first category includes conditions which involve variable names only from the domain model, the second category consists of conditions which consist of variable names only from the use case parameters of the use case, and the third category includes conditions, which contain variable names from both the domain entities and the use case parameters.

For example, in the Withdraw Cash use case example, there may also be a limit on number of withdrawals from a given account (say six), then the guard condition after the refinement step 506 is given by (account.numWithdraw<6) && (amt<account.balance) && (amt>20) && (amt<200). In this guard condition, the condition (account.numWithdraw<six) only includes variable names from the domain model. The condition (amt <account.balance) includes variable names from both the domain model and the use case parameters. While the conditions (amt>20 ) && (amt<200) include variable names only from the use case parameters.

The first category of these conditions may then be used as one component of a goal condition (which represent conditions on the system state) to be given to the planner 314. The parameter names are eliminated from the second category of conditions (using the conditions in the third category) to derive additional conditions on the system state. Thus, using the knowledge that (amt>20) && (amt<200), the condition (amt<account.balance) is translated to (account.balance>20) && (account.balance<200). The entire goal condition is then given by (account.numWithdraw<6) && (account.balance>20) && (account.balance<200). This step is called the rearrange and transform step 506 in the goal generator process diagram of FIG. 5.

This goal condition (and all the rest of the goal conditions derived similarly) is then supplied to the planner 314. The planner 314 generates a sequence of abstract set up sequence to bring the system under test from a user provided initial state to a state which satisfies the goal conditions produced above.

The planner 314 generates a set up sequence component of an abstract test case along with satisfiable constraints that are ultimately realized as a test case by the orchestrator 308.

Given the goals produced by application of the fault model by the goal generator 312, as well as, a starting state for the system being tested, an exemplary embodiment of the present invention may then use a planning algorithm in the planner 314 to determine a sequence of use case invocations that will take the system from a starting to each state which satisfies a goal generated by the goal generator 312.

For the purposes of the present invention, the notion of satisfaction of a goal in a state is determined differently depending on the goal. Boolean goals (not involving Boolean variables) are handled just as for a conventional planning algorithm. Numeric and String expressions and expressions involving Boolean variables are handled by the planner 314 in accordance with an exemplary embodiment of the present invention using the linear constraint solver (not shown) to check their consistency in the state.

Linear constraint solvers are well known to those of ordinary skill in the art and, therefore, a description of linear constraint solvers are not included in the present description. Any linear constraint solver may be used with the present invention.

For the purposes of the present description, planning terminology will be used. For example, instead of “the successful guard-result pairs of normalized use cases” the present description refers to “actions” and instead of “test cases” the present description refers to “plans.” Abstract test cases are “abstract plans” and “concrete test cases” are “concrete plans.” Also, instead of “guard condition” the present description refers to the term “precondition” and instead of “state update” the present description refers to the term “effect.”

Specifically, given an initial state (assumed to be empty unless specified by the model editor 304), a goal generated by the goal generator 312, and a set of actions, the planner 314 uses a graphplan style algorithm to generate a plan.

A graphplan algorithm in accordance with an exemplary embodiment of the present invention starts by building a planning graph data structure. A planning graph data structure simultaneously represents the possible sequences of actions that may lead to a desired goal state. A more detailed description of this algorithm and the structure of a planning graph is available in, for example, Fast Planning Through Planning Graph Analysis by Blum and First, Artificial Intelligence, 90:281-300, 1997.

The behavior of the planner 314 in accordance with an exemplary embodiment of the present invention differs from that of the planner described by the Blum and First reference in several important respects.

First, the planner 314 supports special “Create” and “Delete” actions that cause new constants to be created or removed from the planning graph state. New constants and any facts about those constants are treated exactly as other facts are treated by the algorithm. Deletion of objects may be accomplished by annotating the facts about a deleted object as “deleted.” Facts involving a deleted object are not removed from the state, rather they are propagated to the next state with the “deleted” annotation.

The planner 314 treats these facts no differently than other facts in that state except with respect to the evaluation of expressions of the form “forall x P(x)” in a state with “deleted” facts. For the purposes of this evaluation, the planner 314 may ignore deleted facts of the form “P(c)”, for c a constant.

Another point of divergence between the planner 314 and a conventional planning graph algorithm is in the treatment of numeric, string, and boolean constraints. A numeric constraint is a constraint involving numeric-typed attributes and parameters. For example, “budget(A0)<amt”, where A0 is a constant of type Account, budget( )is a numeric function on Accounts, and amt is a parameter. Evaluation of such numeric constraints in accordance with an exemplary embodiment of the present invention may be performed by a linear constraint solver. Unlike conventional algorithms, an exemplary embodiment of the present invention may also handle string and boolean types.

An exemplary embodiment of the present invention may only allow constraints on strings and booleans that involve the “equals” and “not-equals” operators. For the purposes of evaluation in a state, these constraints may be solved by first translating the problem into a numeric constraint problem and then using a linear constraint solver. This may be done simply by picking distinct numeric constants for each string constant and Boolean constant.

Another point of departure from conventional planning algorithms comes in the handling of sets. An exemplary embodiment of the present invention allows set-typed constants and supports a built-in predicate called “in” which allows the planner to define the constituents of the set. For example, the set S of two projects P0, and P1 can be defined as a pair of facts in the state: {in(P0, S), in(P1, S)}.

In addition, the planner 314 may plan with actions, which add and remove elements from a set. For example, to add the element “P2” to the set S, the action would assert the fact “in(P2, S).”

The planner 314 allows preconditions and effects that refer to functions on sets. The functions supported are: count(S) which gives the number of elements in the set S, sum(S) which gives the sum of the elements in a numeric set S, min(S) which gives the smallest element in a numeric set S and max(S) which gives the largest element in a numeric set S.

After a planning graph structure has been built, the planner 314 follows essentially a conventional graphplan algorithm for extracting a plan. A point of difference is that the plan that is extracted will still have unbound parameters for numeric, string, and Boolean parameter types. A plan with such unbound parameters, is known as an abstract plan. Thus, planner 314 component and the goal generator 312 produces an abstract set up test sequence and an abstract test use case invocation.

The concretizer 316 takes the sequence of use case invocations and the constraints and produces a concrete test case. The constraints for the purpose of this description are numeric constraints on the parameters of use cases that make up a test case. An abstract test case looks something like:

withdraw(a, amt1), withdraw(a, amt2), etc.

The planner 314 maintains additional constraints generated during the planning process. For example, a constraint might require amt2<amt1.

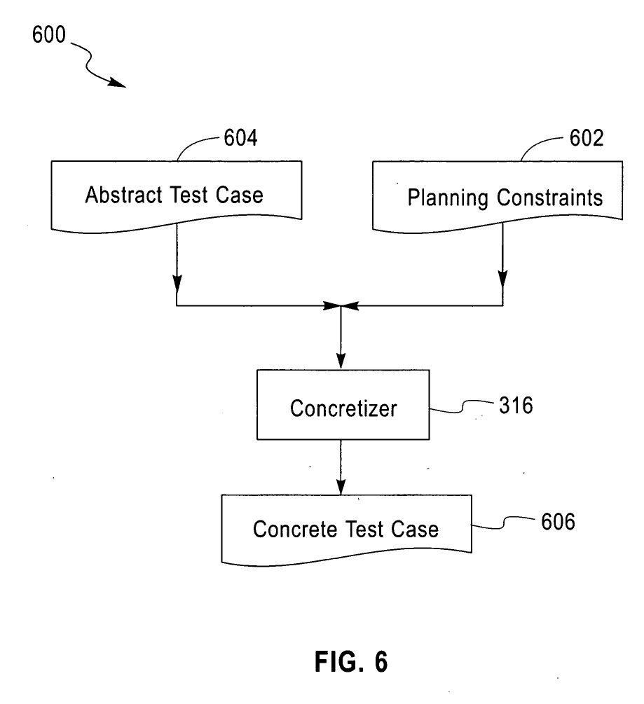

As illustrated by FIG. 6, a set of planning constraints 602 is solved and the values plugged in to the abstract test case 604 by the concretizer 316 to get a concrete test case 606. In this example, one concrete test case might be: withdraw(“my Account”, 100), withdraw(“my Account”, 50). As explained above, the concretizer 316 may use a linear constraint solver to obtain values that satisfy these constraints.

Substituting concrete solution values for these constraints for the parameters of the abstract plan yields a concrete plan. This function is performed by the concretizer 316 in accordance with an exemplary embodiment of the present invention.

Every step of a sequence generated by the planner 314 is an abstract use case, for example, withdraw(a, amt1) in the sequence withdraw(a, amt1), withdraw(a, amt2). The whole sequence is an abstract test case. It is abstract because instead of having numbers or strings of letters for its use case parameters, it has variables. In other words, instead of the concrete use case of: withdraw(“myacct”, 100) it has withdraw(a, amt1).

The concretizer 316 picks values for “a” and “amt1 ” based on the constraints 612 generated during the planning process and substitutes the values into the abstract test case 604 to provide a concrete test case 606. Simply put, an abstract test case has the correct type and order of actions figured out, but not the actual values to get “plugged-in” to the parameters of those actions. The concretizer 316 figures the values out, based on information provide by the planner 314 and substitutes those values into the abstract test case 604.

A reifier 310 in accordance with an exemplary embodiment of the present invention takes a concrete test case and produces an executable test case. If the model editor 304 has specified a template for constructing an executable test case from each use case, then the reifier 310 takes each concrete use case, applies the corresponding execution template and produces an executable test case.

If the model editor 304 has not produced an execution template, then the reifier 310 does nothing and simply produces the set of concrete test cases that were provided by the concretizer 316 to the reifier 310.

Another exemplary embodiment of the present invention generates a state verification sequence. A state verification sequence is used to verify that the system under test appropriately updates the system state. This state verification sequence is appended after the test sequence.

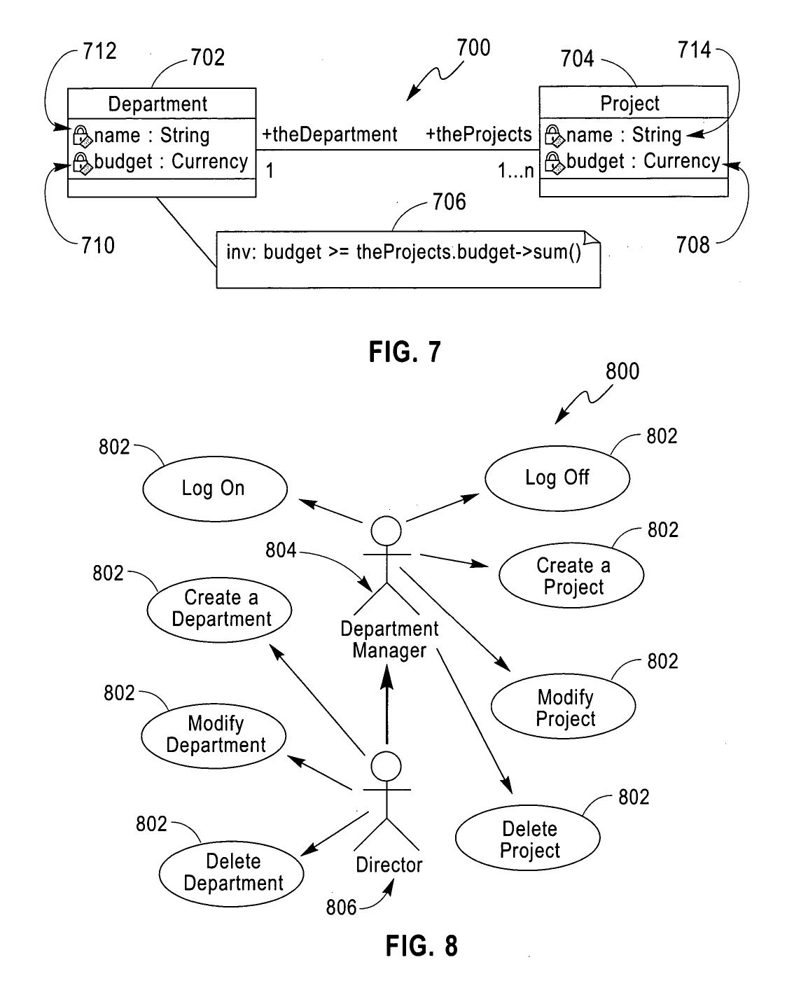

To illustrate these capabilities, consider the following data domain model 700 for a simple system for managing departments 702 and projects 704 as illustrated by FIG. 7. Both departments 702 and projects 704 have names 712 and 714 and budgets 710 and 708. Each department 702 may have zero or more projects 704 associated with it. A project 704 is associated with exactly one department 702.

There is an invariant 706 (also known as a business rule) on this model 700, which states that the sum of all of the budgets 708 for the projects 704 in a department 702 cannot exceed that department's 702 budget 710.

In addition to the domain data model 700, this example has a use case model 800 that illustrates various use cases 802 for manipulating data. There are two actors in this model: a department manager 804, and a director 806 who oversees several departments 702.

Given the use cases 802, an exemplary embodiment of the invention receives an informal sequence of steps detailing the interaction for each particular use case from a domain expert.

For example, for a “Create a Project” use case 802, the system requires authorization for a department manager, queries the department manager for name, department, and budget, receives the name, department, and budget from the department manager, creates a project for that department. In other words, the sequence of steps for the “Create a Project” use case 802 is as follows:

Pre: Department Manager is authorized
1. System queries for name, dept., and budget
2. Department Manager enters name, dept., and budget
3. System creates project associated with specified dept.

The authorization for the department manager 804 is known as a pre-condition because the pre-condition must be satisfied before the remaining steps may be performed.

The query to the department manager 804 is a classified as an output step. The entry of information by the department manager 804 is a classified as an input step and the creation of the project 704 is a classified as a computation step.

Given the above informal software system model, an exemplary embodiment of the present invention creates a formal model in accordance with the following description.

In a Department-Project Move a Project 802 use case, a test sequence may be as described after the planning step. However, the state updates corresponding to the Move Project P From Dept A to Dept B involves the following state updates:
(1) Delete a link between Dept A and Project P, and
(2) Create a link between Dept B and Project P.

To verify that these state updates are actually implemented correctly, an exemplary embodiment of the present invention may invoke “Browse Department A” to verify that the project P is not on A's list of projects, and also invokes “Browse Department B” to verify that project P is indeed on B's list of projects.

This step is performed by the Orchestrator 308 by identifying “Observer” use cases. An observer use case enables the user of the system under test to inspect the internal system state. An exemplary embodiment of the present invention analyzes the state update part of the use cases to identify those use cases, which assign a domain variable to an output parameter of the use case.

Mapping is then derived between various domain variables and the corresponding observer use cases by the orchestrator 308. Similarly, an exemplary embodiment of the present invention identifies a mapping between a use case and the corresponding domain variables that the use case updates. During the test generation process, for each invocation of a use case, which updates a given set of domain variables, an invocation of all the observer use cases is appended to verify the system state.

An exemplary embodiment of the present invention creates all the components of an abstract test case using the orchestrator 308. The orchestrator 308 invokes the goal generator 314 to generate the goal conditions for the planner 314, and also produces an abstract test use case invocation. The orchestrator 308 then creates concrete test cases. An orchestrator 308 takes the abstract set up sequence, an abstract test use case invocation, and an abstract verification sequence and uses the concretizer 316 to convert this abstract test case into a concrete one as described above.

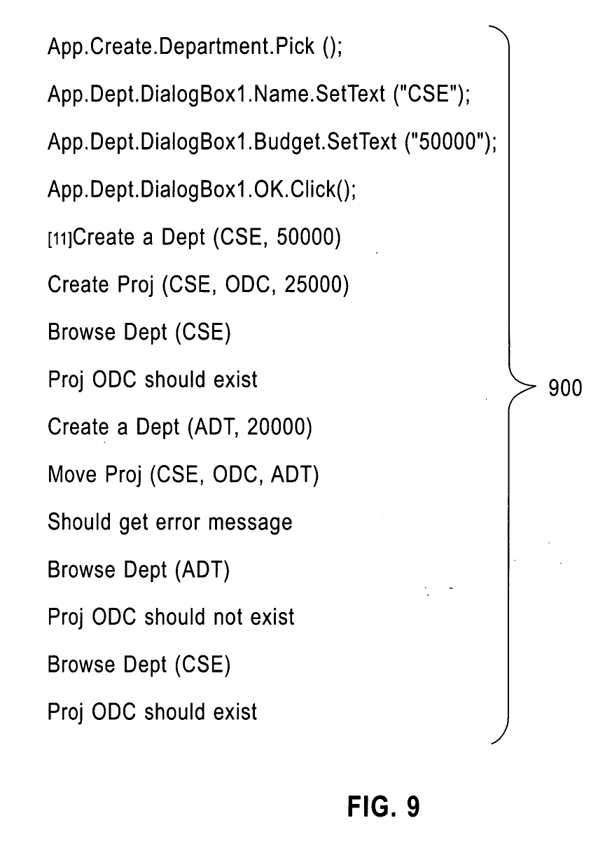

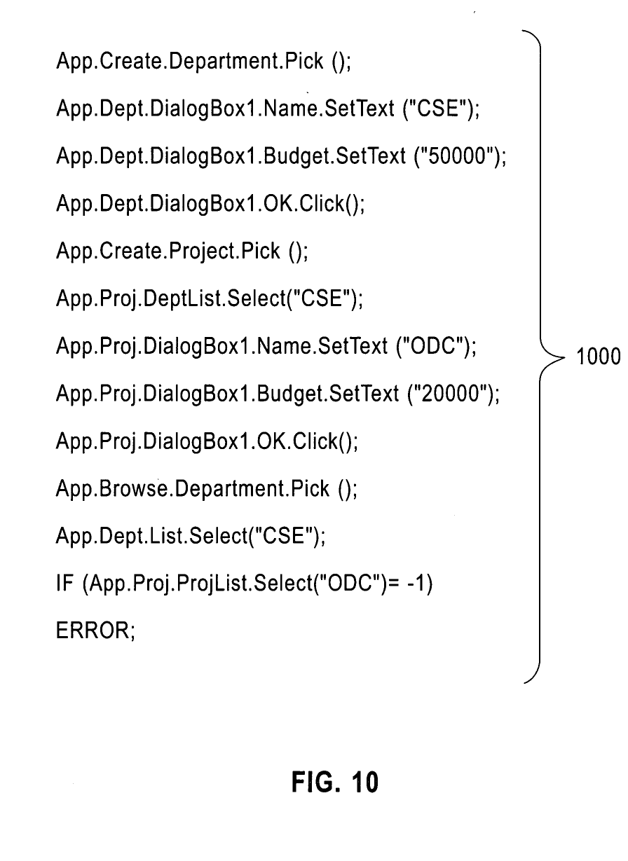

FIG. 9 illustrates an example of concrete test case 900. FIG. 10 illustrates the executable test case 1000 produced by a reifier 310 in accordance with an exemplary embodiment of the present invention. Each line of the test case in FIG. 9 is a use case invocation. Each such use case invocation is translated into one or more lines of executable code in FIG. 10 which illustrate one such translation for a use case called “Create a Dept.”

FIGS. 9 and 10 are different because FIG. 9 illustrates a test case that includes use case invocations and FIG. 10 illustrates a sequence of executable instructions—corresponding to those use cases—which can be executed on a computer to perform the function of the use case. For example, “Create a Dept(CSE, 50000)” may be executed by a machine simply by executing its corresponding statements in the executable test case.

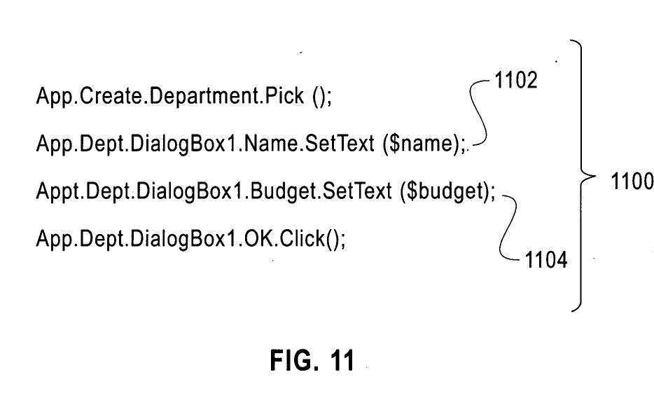

Specifically, for this example, the model editor 304 has defined an execution template 1100 for “Create a Dept,” which is illustrated in FIG. 11. This execution template 1100 has two parameters—variables with a prefix of “$”-$nam 1102e and $budget 1104. The reifier 310 takes the parameters from the use case invocation—“CSE” and “50000” and substitutes them in order for the variables $name 1102 and $budget 1104 in the template 1100 to derive the corresponding executable steps which are inserted in order into the executable test case. The result of the substitution for this example is the first four lines of the executable test case in FIG. 10.

A user-defined template, defined by the modeler using the model editor 304, is applied by the reifier 310 to produce executable code from a concrete use case. Each use case can be (at a user's discretion) associated with a piece of code that can be executed on some target system to perform the function of the use case. For example, for the withdraw cash use case an associated template (provided by the modeler using the GUI) may be:

```
Withdraw($acct, $amt) {
  Account a = Account.getInstance($acct);
  a.balance = a.balance − $amt.
```

Things marked with “$” in the template are places where the reifier 310 may substitute values from a use case invocation in the (concrete) test case generated by the concretizer 316. For example, if the concretizer 316 outputs “withdraw(“MyAcct”, 100)” the value “MyAcct” would be substituted for $acct everywhere in the template as would the value 100 for $amt. The resulting piece of code would look like:
Account a=Account.getInstance(“MyAcct”);
a.balance=a.balance−100;

This code snippet might then be executed against the implementation of the system (written in java in this case) as one step of a test case.

FIGS. 7 and 8 illustrate the operation of an exemplary embodiment of a planner 314 in accordance with an exemplary embodiment of the present invention on an example system 700 that manages departments 702 and projects 704.

As shown in FIG. 7, the exemplary system 700 includes a class of object called a “department” 702 and a class of object called a “project” 704. The departments 702 have an attribute labeled “budget” 710 which is real-valued and an attribute labeled “projs,” which is holds a set of projects 704. The projects 704 have a real-valued budget attribute 708. There is also a business rule 706 that the budget 710 of the department 702 must be greater than or equal to the sum of the budgets 708 of all the projects 704 within the department 702. Treating budget and projs as functions on their respective classes, this constraint may be written as follows:
budget(d)>=sum({budget(p)|in(p, projs(d)}).

There are two actions, which create new objects:
1. ConstructDepartment(pBudget: Real) whose precondition is “true” (meaning they are universally applicable) and whose effects are to introduce a new constant—call it NEW_DEPT, of type Department with budget=pBudget, and to assert projs(NEW_DEPT)={ }. In general, a model might include a parameter for initializing the projs attribute but it is excluded here to make the example more interesting.
2. ConstructProject(pBudget: Real) whose precondition is also “true” and whose effects are to introduce a new constant NEW_PROJECT and to assert budget(NEW_PROJECT)=pBudget.

In the example system there are two actions which can change departments 702 and projects 704 once they are created.

1. addProject(d : Department, p : Project)
pre: (not in(p, d)) and budget(d) <= budget(p) + sum(*{budget(p′) | in(p′,
projs(d)})
effects: in(p, d)
2. transferProject(d1 : Department, d2 : Department, p : Project)
pre: (in(p, d1)) and budget(d2) <= budget(p) + sum({budget(p′) | in(p′,
projs(d2)})
effects: not in(p, d1); in(p, d2)

The parameters for the actions are listed in parentheses after the operation name. Each parameter is given in the form “name: type”. The action preconditions follow the label “pre”; the action effects are given in a semi-colon separated list after the label “effects”. There is a set membership predicate written “in”. An expression of the form “in(s, S)” means that the element “s” is in the set “S”.

1. addProject(d : Department. p : Project)
pre: (not in(p, d)) and budget(d) ’1= budget(p) + sim({budget(p′) | in(p′,
projs(d)})
effects: in(p, d)
2. transferProject(d1 : Department, d2 : Department, p : Project)
pre: (in(p, d1)) and budget(d2) <= budget(p) + sum({budget(p′) | in(p′,
projs(d)})
effects: not in(p, d1); in(p, d2)

In the example, the initial state is empty. The goal is:
In(p1, projs(d1)) and budget(p1)>budget(d2) and in(p2, projs(d2)) and p1!=p2.

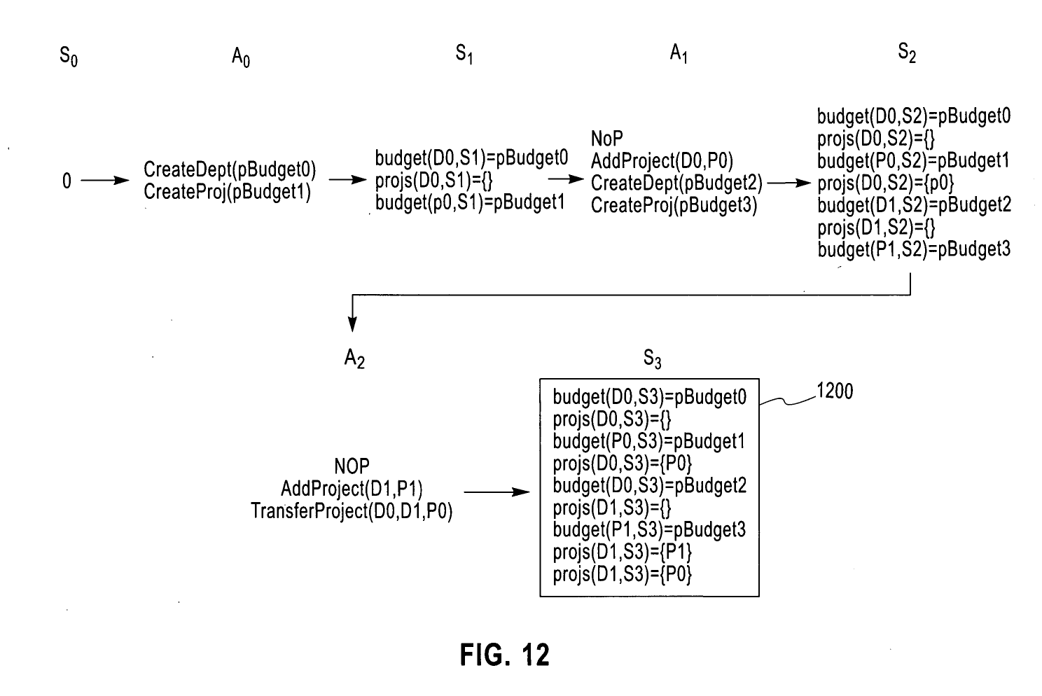

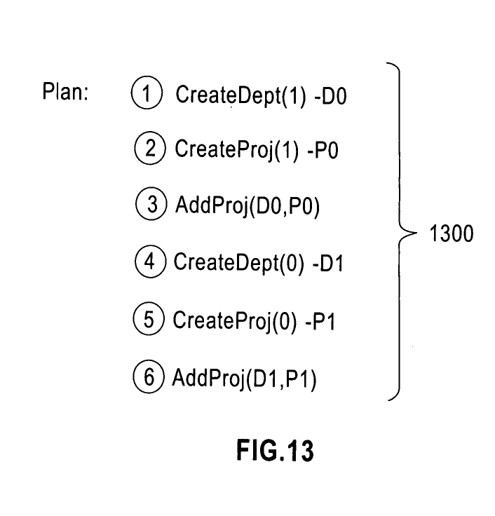

FIG. 12 illustrates a planning graph 1200 built for the example model above and FIG. 13 illustrates a linearized plan 1300 that was extracted from the planning graph 1200 by an exemplary embodiment of the present invention. The linearized plan 1300 may be used for testing the system.

After execution of the linearized plan 1300 there should be two departments, each with a project, and one of the projects will have a budget greater than the budget of the department that does not own the project.

The goal of this planning problem is to create two departments each which own a project (not the same project) and such that the project owned by the first department has a budget greater than the budget of the second department. The example goal was chosen because it describes the state necessary to test whether the implementation of the Transfer Project operation has correctly checked the precondition. If it has failed to check the budget constraint, it will (incorrectly) allow the transfer of p1 from d1 to d2 in the goal state resulting in a violation of the business rule.

While the invention has been described in terms of several exemplary embodiments, those skilled in the art will recognize that the invention can be practiced with modification.

Further, it is noted that, Applicant's intent is to encompass equivalents of all claim elements, even if amended later during prosecution.

What is claimed is:

1. A method for automatically generating a test case for object-oriented software, comprising:
providing, in a computer, a model of said object-oriented software;
determining, in a computer, a test state for said object-oriented software; and
determining, in a computer, a sequence of test steps for said object-oriented software based upon said test state.

2. The method of claim 1, wherein said model specifies the structure and behavior of said object-oriented software, wherein said behavior of said object-oriented software specifies an action, and wherein said determining said sequence of test steps comprises applying a planning algorithm based upon said action.

3. The method of claim 2, wherein said action comprises one of creation of a new object, deletion of an existing object, creation of a link between objects, and updating an attributes of an object.

4. The method of claim 3, wherein updating an attribute of an object comprises updating a numerical attribute of the object.

5. The method of claim 1, wherein said determining comprises applying a fault model to said model of said object-oriented software to identify said test state.

6. The method of claim 5, wherein said model of said object-oriented software comprises at least one of a pre-condition and a post-condition.

7. The method of claim 6, wherein said applying said fault model comprises applying said fault model to said at least one of said pre-condition and said post-condition.

8. The method of claim 1, wherein said determining said sequence of test steps comprises applying a planning algorithm.

9. The method of claim 8, wherein said applying a planning algorithm comprises verifying the operation of said object-oriented software.

10. The method of claim 8, wherein said applying said planning algorithm comprises applying said planning algorithm based upon said test state.

11. The method of claim 8, wherein said applying said planning algorithm comprises applying said planning algorithm based upon said model of said object-oriented software.

12. The method of claim 8, wherein applying said planning algorithm comprises constructing a data structure holding an action.

13. The method of claim 12, wherein said data structure comprises a planning graph.

14. The method of claim 13, wherein said determining said sequence of test steps further comprises extracting sequences of actions from said planning graph.

15. The method of claim 14, wherein said constructing said data structure comprises using a linear constraint solver to construct said data structure.

16. The method of claim 1, wherein said model of said object-oriented software comprises a business rule that constrains the behavior of the object-oriented software.

17. The method of claim 16, wherein said determining said sequence of test steps comprises applying a planning algorithm based upon said business rule.

18. A method for deploying computer infrastructure for automatically generating a test case for object-oriented software, comprising integrating computer-readable code into a computing system, the computer-readable code comprising:
instructions for providing a model of said object-oriented software;
instructions for determining a test state for said object-oriented software; and
instructions for determining a sequence of test steps for said object-oriented software based upon said test state.

19. A signal bearing medium executable by a digital data processing unit for automatically generating a test case for object-oriented software, comprising:
providing a model of said object-oriented software;
determining a test state for said object-oriented software; and
determining a sequence of test steps for said object-oriented software based upon said test state.

20. A system for automatically generating a test case for object-oriented software, comprising:
means for providing a model of said object-oriented software;
means for determining a test state for said object-oriented software; and
means for determining a sequence of test steps for said object-oriented software based upon said test state.
